(19) United States
(12) Patent Application Publication
(10) Pub. No.: US 2020/0245592 A1
(43) Pub. Date: Aug. 6, 2020

(54) Animal Harness

(71) Applicant: William Wagner, Hoboken, NJ (US)

(72) Inventor: William Wagner, Hoboken, NJ (US)

(21) Appl. No.: 16/857,637

(22) Filed: Apr. 24, 2020

Related U.S. Application Data
(63) Continuation-in-part of application No. PCT/US18/58631, filed on Nov. 1, 2018.
(60) Provisional application No. 62/580,518, filed on Nov. 2, 2017.

(51) Int. Cl. A01K 27/00

(52) U.S. Cl. CPC A01K 27/002; A01K 27/005

(57) ABSTRACT

An animal harness is flexible and includes a dorsal portion and a ventral portion removably coupled together. A front and rear sections of the harness include engagement members coupling the dorsal and ventral portions thereby providing a front opening, leg openings and a rear opening. The harness includes a plurality of attachment members. The modular design of the animal harness allows accessories to be securely attached or removed to and from the attachment members, which reduces manufacturing costs, as each accessory does not require its own method of securely attaching to the animal. The animal harness also allows modules to be added or replaced individually, reducing the cost of ownership, and also allows future accessories to integrate into the existing harness without having to replace the entire harness.

### CROSS-REFERENCE TO RELATED APPLICATION

This application claims priority to International Application No. PCT/US18/58631, filed on Nov. 1, 2018, which claims priority to U.S. Provisional Application No. 62/580,518, filed on Nov. 2, 2017, which are incorporated by reference in their entireties.

### FIELD OF INVENTION

The present invention relates to animal harnesses, more specifically to a modular harness for four-legged animals such as dogs and cats.

### BACKGROUND OF THE INVENTION

Unlike a collar, which is secured around the neck, a dog harness is secured by the body. This provides a more secure attachment and alleviates the pressure on the neck.

Most dog harnesses in the prior art secure around the body and have holes for the front legs. Fasteners secure the harness and allow the harness to be adjusted to the proper size. Dog harnesses for the hind legs and for all four legs also exist in the prior art.

However, dog harnesses in the prior art lack a means for securely attaching non-standard accessories thereto. That is, harnesses include rings for attaching a leash but other accessories such as clothing and medical accessories are often worn by the dog separate from the harness.

For example, Elizabethan collars secure around the neck of the dog and prevent the dog from scratching, biting, or licking wounds. The collars must be rigid enough to prevent the dog from bending it. However, because the Elizabethan collar is independently secured to the pet's neck and not connected to any other part of the pet, there is a high possibility of the pet removing the same. Furthermore, the rubbing of the rigid collar against the neck of the dog can cause discomfort, further causing the dog to attempt to remove the collar.

As other examples, other dog garments and attachments in the prior art include boots, costumes, diapers, leashes, flea collars, training collars, wireless fence receivers, trackers, and cameras. However, as separate devices, they do not provide a seamless and secure fit. More specifically, these accessories and devices are independently secured to the pet and therefore the possibility of them being removed by the pet, on purpose or inadvertently, is quite high.

Therefore, a need exists for a modular animal harness that enables increased comfort and customizability for securely attaching accessories and the like.

Harnesses for animals are known in the art; for example, as described in U.S. Pat. Nos. 6,571,745 and 7,918,192; and U.S. App. Pub. Nos. 2010/0199927 and 2010/0277945. However, the harnesses in each of these patent documents lack the comfort or customizability needed for a modular animal harness. U.S. Pat. No. 6,571,745 describes a dog pack harness with a collar 11 around the neck of the dog. U.S. Pat. No. 7,918,192 describes a multi-purpose pet utility vest which requires a separate harness beneath the vest for attaching harness-style leads. U.S. Published Application No. 2010/0199927 describes a tactical vest for canines which has shoulder straps 79 and strap portions 79A, 79B which may interfere with the movement of the dog. U.S. Published Application No. 2010/0277945 describes interchangeable attachments for accessories for pets which preferably use hook-and-loop fasteners for attaching accessories, which may not securely attach such accessories.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present invention is for an animal harness that comprises a flexible harness having a front opening, a rear opening, a top end, a bottom end, a leg opening, a side opening, a front fastener, a rear fastener, a leg fastener, a top fastener, a top base, and a side fastener.

The advantages to the present invention are numerous. The modular design allows accessories to be securely attached or removed. This can reduce manufacturing costs, as each accessory does not require its own method of securely attaching to the dog. It also allows modules to be added or replaced individually, reducing the cost of ownership. Finally, it allows future accessories to integrate into the existing harness without having to replace the entire harness.

In an example embodiment, the present invention is an animal harness including: a dorsal portion for fitting on a dorsal side of an animal; a ventral portion for fitting on a ventral side of the animal; and a first attachment member for removably attaching the dorsal portion to the ventral portion. The dorsal portion and the ventral portion are portions of a single harness member. The single harness member has a front opening for passing the head of the animal therethrough. The first attachment member is selected from a zipper, a hook-and-loop fastener, a button, a hook, a buckle, and a clip. The dorsal portion includes a hook for removably attaching a leash to the dorsal portion. The dorsal portion includes a name tag and/or a product label. The dorsal portion and the ventral portion form a front opening for passing the head of the animal therethrough. The dorsal portion and the ventral portion form a side opening for passing a leg of the animal therethrough. At least one of the dorsal portion and the ventral portion includes a second attachment member for removably attaching an item to the animal harness.

In an alternative embodiment, the present invention is an animal harness including: a dorsal portion for fitting on a dorsal side of an animal; a ventral portion for fitting on a ventral side of the animal; and a first attachment member on at least one of the dorsal portion and the ventral portion for removably attaching an item to the animal harness. The dorsal portion and the ventral portion are portions of a single harness member. The single harness member has a front opening for passing the head of the animal therethrough. The animal harness may also include a second attachment member for removably attaching the dorsal portion to the ventral portion. The second attachment member is selected from a zipper, a hook-and-loop fastener, a button, a hook, a buckle, and a clip. The dorsal portion includes a hook for removably attaching a leash to the dorsal portion. The dorsal portion includes a name tag and/or a product label. The dorsal portion and the ventral portion form a front opening for passing the head of the animal therethrough. The dorsal portion and the ventral portion form a side opening for passing a leg of the animal therethrough. The first attachment member is selected from a zipper, a hook-and-loop fastener, a button, a hook, a buckle, and a clip.

In another alternative embodiment, the present invention includes a method having the steps of positioning a dorsal portion adjacent to a ventral portion to form an animal harness having an opening; passing a portion of an animal through the opening; removably attaching the dorsal portion to the ventral portion using a first attachment member; and removably attaching an item to the animal harness using a second attachment member.

### BRIEF DESCRIPTION OF THE SEVERAL VIEWS OF DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a side view of an animal harness of the present invention on a dog.

FIG. 2 is a side view of an alternative embodiment of the animal harness on a dog.

FIG. 3 is a side view of a second alternative embodiment of the animal harness on a dog.

FIG. 4 is a top plan view of a dorsal portion of the second alternative embodiment of the animal harness.

FIG. 5 is a bottom plan view of a ventral portion of the second alternative embodiment of the animal harness.

FIG. 6 is a top plan view of a dorsal portion of the third alternative embodiment of the animal harness.

FIG. 7 is a bottom plan view of a ventral portion of the third alternative embodiment of the animal harness.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION OF THE INVENTION

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left are used to describe the accompanying figures. The terminology includes the words above specifically mentioned, derivatives thereof, and words of similar import.

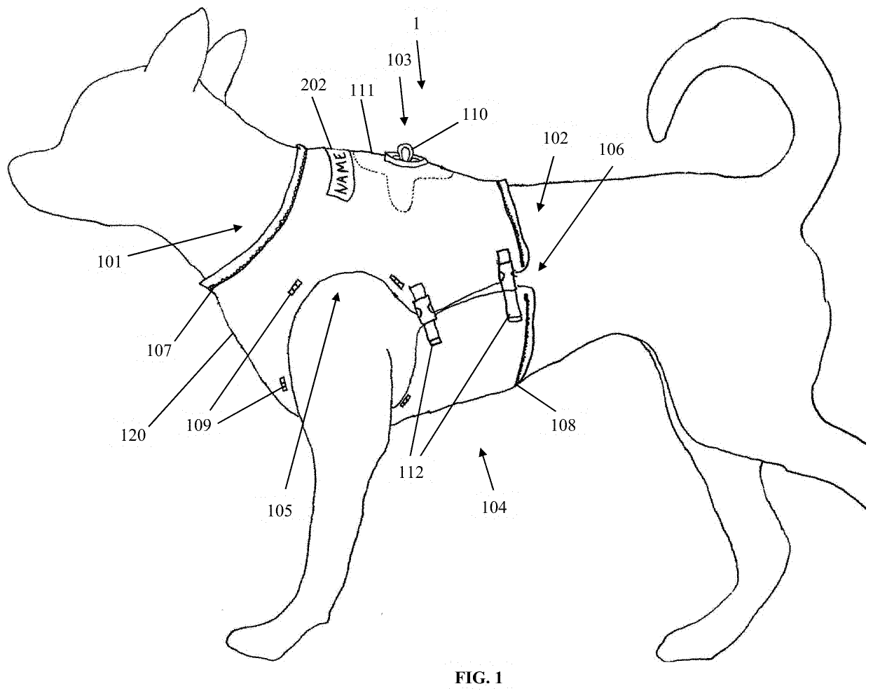

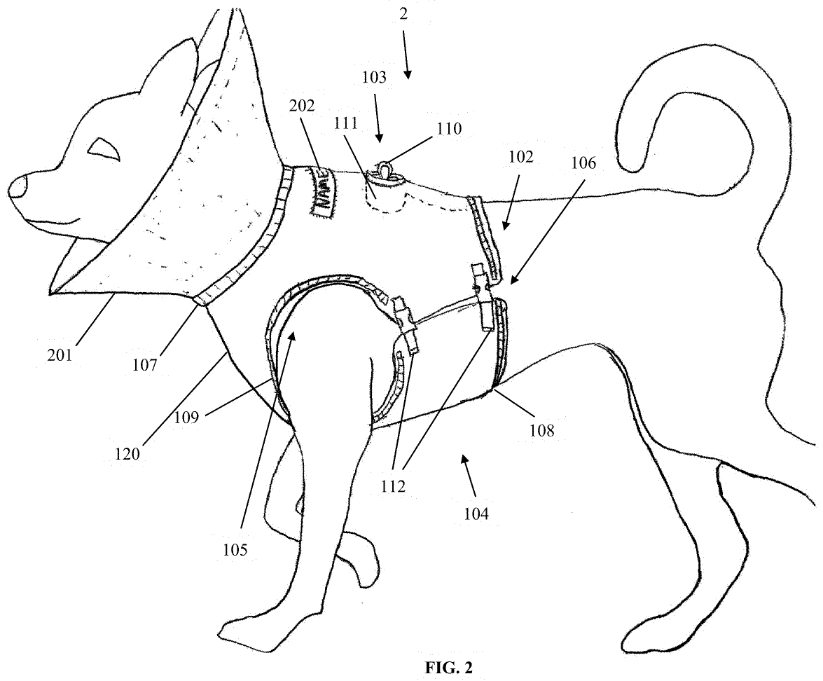

Referring to FIGS. 1-2, embodiments of an animal harness 1, 2 of the present invention are shown. In these embodiments, the harness 1, 2 is shown installed on a dog. In general, the harness 1, 2 is composed of any known flexible and durable material, such as vinyl or fabric. The harness 1, 2 includes a front opening 101 having a front fastener 107, and an opposing rear opening 102 having a rear fastener 108. A top end 103 and a bottom end 104 extend from the opposing openings 101, 102. A pair of leg opening 105 are positioned on the bottom end 104 intermediate the opposing openings 101, 102, and at least one leg fastener 109 is coupled with the at least one leg opening 105. A side opening 106 is positioned on each side of the harness 1, 2 between the leg opening 105 and the rear opening 102 and is detachably coupled with a side fastener 112. A top base 111 along with a top fastener 110 are positioned on the top end 103 of the harness 1, 2 intermediate the opposing openings 101, 102.

The harness 1, 2 may be made of any flexible material including nylon, polyester, leather, cotton, and wool. The material could also be water-proof or water-resistant. In addition, various other materials could be attached to or integrated with the harness to provide other advantages. For example, a reflective material could be used to provide better visibility at night time.

Referring again to FIGS. 1-2, the front opening 101 is sized to be capable of passing a head of the animal therethrough. The leg opening 105 is sized to be capable of passing a leg of the animal therethrough. The rear opening 102 is capable of fitting around a torso of the animal. In the exemplar embodiment, there are two leg openings 105, one for each front leg. One of ordinary skill in the art would recognize from the present disclosure that the harness 1, 2 can be of various sizes and shapes to allow for a wide range of animal sizes and shapes.

In the exemplar embodiments, as shown in FIGS. 1-2, the side opening 106 extends from the rear opening 102 to the leg opening 105 and is closed by the side fastener 112. In the exemplar embodiments, the side fastener 112 is an adjustable strap coupled to a snap buckle. However, other fasteners are possible including zippers, hook-and-loop fasteners, buttons, hooks, and clips.

The side opening 106 enables the harness to be placed around the legs of the animal with ease. That is, the individual handling the animal need not position the animal's legs into predetermined leg holes. Instead, the harness 1, 2 is installed on the animal while the side opening 106 are open and the animal's legs are secured by closing the side opening 106 and engaging the side fastener 112. This is could be advantageous for larger animals where the caregiver has difficulty manipulating the animal's legs. Furthermore, a more customizable fit is provided with two side openings 106. When the side fastener 112 is fastened, the harness 1, 2 is securely attached to the animal and cannot be removed without unfastening the side fasteners 112.

In another embodiment, the side opening 106 may further extend to the front opening 101 and be closed by a plurality of side fasteners 112. In yet another embodiment, there may be only one side opening 106 so that one leg opening 105 is predetermined while the opposing leg opening 106 is formed with the closing of the side opening 106 as described above. In this embodiment, the number of fasteners is reduced, thus reducing manufacturing cost.

In a further alternative, the side opening could be eliminated and be constructed of a continuous fabric while the top end 103 having an opening extending from front to back. The opening could then be provided with fasteners and integrated with the other structural elements on the top end 103 which are described below.

Referring to FIGS. 1 and 2, a thoracic portion 120 of the harness 1, 2 could be provided with additional padding to minimize tracheal pressure as a result of pulling of a leash from the top end 103.

Still referring to FIGS. 1-2, the front fastener 107, rear fastener 108, and leg fastener 109 are near an edge of the front opening 101, rear opening 102, and leg opening 105, respectively. In the embodiment shown in FIG. 1, the front and rear fasteners 107, 108 are zippers and the leg fasteners 109 are hook-and-loop fasteners. In the embodiment shown in FIG. 2, the leg fastener 109 is also a zipper. In other embodiments, the fasteners 107, 108, 109 may be buttons, clips, hooks, or buckles.

The front, rear, leg, and side fasteners 107, 108, 109, 112 are located on an outer surface of the harness to prevent contact with the dog, avoiding irritation and snagging, with hair. In other embodiments, flaps or plackets can cover the fasteners 107, 108, 109, 112 to conceal and protect the fasteners 107, 108, 109, 112 from dirt, damage, and snagging.

The front fasteners 107 could be used to couple head and neck accessories; the leg fasteners 109 could be used to couple shoulder and front leg accessories; and the rear fasteners 108 could be used to couple hind-half accessories. More specifically, accessories such as Elizabethan collars 201 (shown in FIG. 2), diapers, costumes, boots, and collars, such as flea collars, can be attached to the front, rear, and leg fasteners 107, 108, 109. With such attachment means or members, the accessories are secure to the animal's body and the likelihood of the accessories being inadvertently removed from the body is greatly reduced. With respect to clothing attachments, such attachment means or members provide insulation from inclement weather such as cold air and rain. With respect to medical accessories such as Elizabethan collars 201, such attachments means or members provide a secure coupling that is difficult if not impossible for an animal to remove.

In FIG. 2, an inventive Elizabethan collar 201 is shown. In this embodiment, the collar 201 comprises a sturdy, padded fabric having internal struts. The internal struts, preferably made of plastic, provide a non-collapsible structure. In this embodiment, the front fastener 107 is a zipper and the Elizabethan collar 201 includes a matching zipper such that the Elizabethan collar 201 is securely attached to the front fastener 107.

Referring again to FIGS. 1-2, the top fastener 110 is coupled to the top base 111 by fusing, threading, or other secure means. In another embodiment, the top fastener 110 is formed integral to the top base 111. A secure coupling is necessary to ensure that the top fastener 110 does not unintentionally detach from the top base 111.

In the exemplar embodiments, the top fastener 110 is a loop with a threaded base. The loop can be coupled to a clip on an accessory (not shown) such as a leash or the threaded base can be coupled to threaded accessories (not shown) such as an umbrella.

The top base 111 is coupled to a top portion of the harness. The top base 111 is made of a substantially rigid material to secure the top fastener 110 and provide stability to accessories attached to the top fastener 110. In the embodiment shown in FIG. 1, the top base 111 is in the shape of a plus sign with ends aligned with the front-to-back axis and the left-to-right axis of the harness. In the embodiment shown in FIG. 2, the top base 111 is in the shape of a T.

In the exemplar embodiments, the top base 111 is coupled to the harness by placing the top base 111 between two layers of the harness and stitched into place. The top fastener 110 is exposed through a reinforced hole in the top layer of the harness. The top base 111 may be curved to conform to the body of the dog.

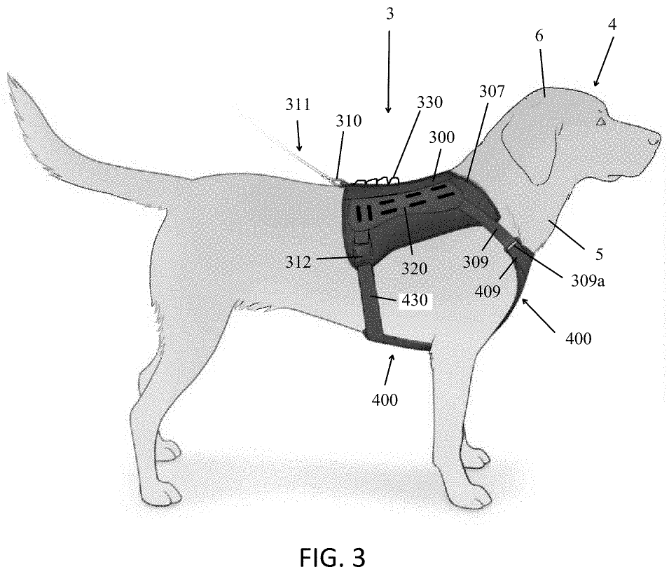

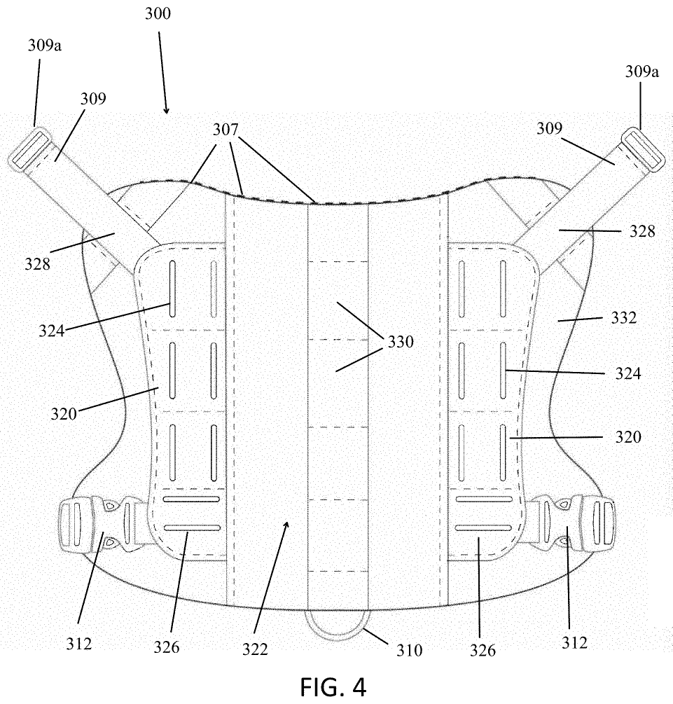

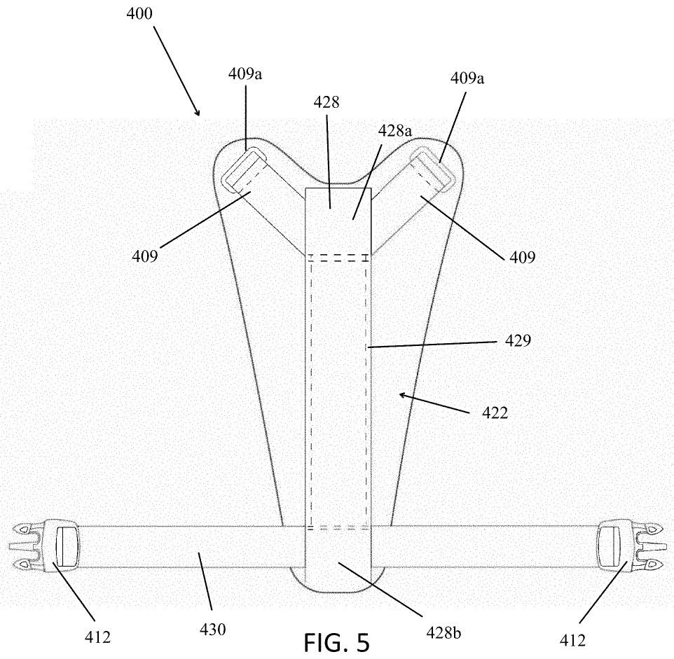

FIG. 3 is a side view of a second alternative embodiment of the animal harness on a dog. In the second alternative embodiment, the harness 3 includes a dorsal portion 300, as shown in greater detail in FIG. 4, and includes a ventral portion 400, as shown in greater detail in FIG. 5, which are combined to form the overall harness 3 on the dog 4. In general, the harness 3 is composed of any known flexible and durable material, such as vinyl or fabric.

In particular, the dorsal portion 300 has a hook 310 for allowing attachment of a leash 311, such that the dog 4 may be controlled without a collar around the neck 5 of the dog 4, so that the dog 4 is not choked when the leash 311 is pulled by a person or if there is increased tension on the leash 311.

The portions 300, 400 are removably coupled together using portion engagement or attachment members 309, 312, 409, 412, respectively, which may include zippers, hook-and-loop fasteners, buttons, hooks, clips, and/or buckles. As shown in FIGS. 3-5, the attachment members 309, 409 at a front portion of the harness 3 include a double loop buckle 309a and a single loop 409a. The front attachment members 309, 409 are made adjustable by having the strap portion of the attachment member 309 positioned through each loop of the double loop buckle 309a at a top portion thereof, positioned through the single loop 409a and then fixed to a bottom portion of the double loop buckle 309a. Alternatively, this could be also be accomplished with the attachment member 309 being a hook-and-loop fastener. The engagement or attachment means 312, 412 at a rear portion of the harness 3 are coupled together by clip-on fasteners. The combination of the portions 300, 400 forms a front opening through which the head 6 and neck 5 of the dog 4 may be passed therethrough. Alternatively, the portions 300, 400 may be coupled together using the engagement or attachment members 309, 312, 409, 412 after the portions 300, 400 are positioned about the upper body and the neck 5 of the dog 4. In addition, the dorsal portion 300 includes at least one item attachment member 320 for allowing items to be attached to the harness 3.

FIG. 4 is a top plan view of the dorsal portion 300 of the animal harness 3, which is positioned on at least the dorsal portion of the animal 4; that is, the back portion of the animal 4 as well as the upper sides of the animal 4. The dorsal portion 300 includes a base 332 having a light-weight, breathable fabric. The dorsal portion 300 has the engagement or attachment members 309, 312, which include zippers, hook-and-loop fasteners, buttons, clips, hooks, and/or buckles.

In addition, a mesh 322 is included, which may be composed of vinyl or fabric, and which extends longitudinally along the central length of the dorsal portion 300. The mesh 322 is stitched onto the base 332 and is preferably made of a durable material that can withstand stress.

At least one item attachment member 320, in the form of a Modular Lightweight Load-carrying Equipment (MOLLE) panel, is disposed on at least one side of the mesh 322, with the item attachment member 320 including at least one site 324, 326, oriented in parallel to or perpendicular to the longitudinal axis of the dorsal portion 300, respectively. The attachment member 320 is stitched onto the base 332 at various locations surrounding the sites 324, 326 and is made of a durable but flexible material that can withstand stress. The site 324, 326 may be a slot for receiving a hook, a protrusion such as a hook, a portion of hook-and-loop fastener material, or any other mechanism for removably attaching various items, accessories, or devices, allowing a pet owner or animal minder to customize the harness 3 to meet the lifestyle of the pet and/or medical needs.

For example, the various items, accessories, or devices may include wireless fence receivers, trackers, and cameras which are attached to one of the sites 324, 326 using zippers, hook-and-loop fasteners, buttons, clips, hooks, and/or buckles in a manner known in the art of attaching items to one or more of the sites 324, 326. In another example, a holder, such as a bag, for holding a toy, such as a ball or a chew toy, may be attached to one of the sites 324, 326 using zippers, hook-and-loop fasteners, buttons, clips, hooks, and/or buckles in a manner known in the art of attaching items to one or more of the sites 324, 326, so that the animal 4 may carry its own toys for play with an owner or animal minder. Similarly, medicine for the pet may be removably retained at one or more of the sites 324, 326, so that the animal 4 may carry its own medicine for treatment during a typical treatment regimen.

As shown in FIGS. 3-4, the mesh 322 may also include at least one strap or loop 330 operably coupled thereto by way of a plurality of horizontal stitching forming gaps therebetween, which can be used to additionally removably secure items, accessories, or devices to the dorsal portion 300. In this embodiment, the strap or loop 330 is one continuous fabric extending along the mesh 332 and is constructed of a durable fabric able to withstand stress. The dorsal portion 300 also includes regions 328 for further attaching items to the harness 3. For example, zippers, hook-and-loop fasteners, buttons, hooks, clips, and/or buckles may be disposed at such regions 328 to attach items, accessories, or devices thereto, as described above. As well, the regions 328 are loops that could be utilized to attach items. The dorsal portion 300 optionally includes a front attachment member 307, such as zippers, hook-and-loop fasteners, buttons, clips, hooks, and/or buckles, for attaching items, accessories, or devices, such as medicine and/or medical devices, an animal license or identification (ID) tag, a flea collar, wireless fence receivers, trackers, cameras, a hood for inclement weather or for cosmetic or decorative purposes, other cosmetic/decorative accessories, and/or an Elizabethan collar 201 such as that shown in FIG. 2 and described above, to the neck area of the dorsal portion 300. For example, the front attachment member 307 could be a zipper and the Elizabethan collar 201 could include a matching zipper such that the Elizabethan collar 201 is securely attached to the front attachment member 307 like shown in FIG. 2.

FIG. 5 is a bottom plan view of the ventral portion 400 of the animal harness 3, which is positioned on at least the ventral portion of the animal 4; that is, the front and/or chest portion of the animal 4 as well as the lower sides of the animal 4. The ventral portion 400 has engagement or attachment members 409, 412 that include zippers, hook-and-loop fasteners, buttons, clips, hooks, and/or buckles, for complementarily and removably or adjustably coupling with the attachment members 309, 312 respectively in FIGS. 3-4. A strap 430 is operably coupled with each attachment member 412. A mesh 422 is included, which may be composed of vinyl or fabric, and which extends longitudinally along the central length of the ventral portion 400, with the attachment members 409, 412 disposed at least on one side of the mesh 422. The mesh 422 is preferably light-weight and breathable.

The ventral portion 400 also includes a lower region 428 operably coupled to the mesh 422 at each end as well as portions 429 therebetween. The lower region 428 is preferably a durable material that could withstand stress. A rear portion 428b of the lower region 428 is kept open while the strap 430 extends therethrough between the rear portion 428b and the mesh 422. The rear portion 428b is used for further attaching items to the harness 3. As examples, zippers, hook-and-loop fasteners, buttons, hooks, clips, and/or buckles may be disposed on the rear portion 428b to attach items, accessories, or devices thereto, as described above, such as an animal license or identification (ID) tag, a flea collar, wireless fence receivers, trackers, and/or cameras.

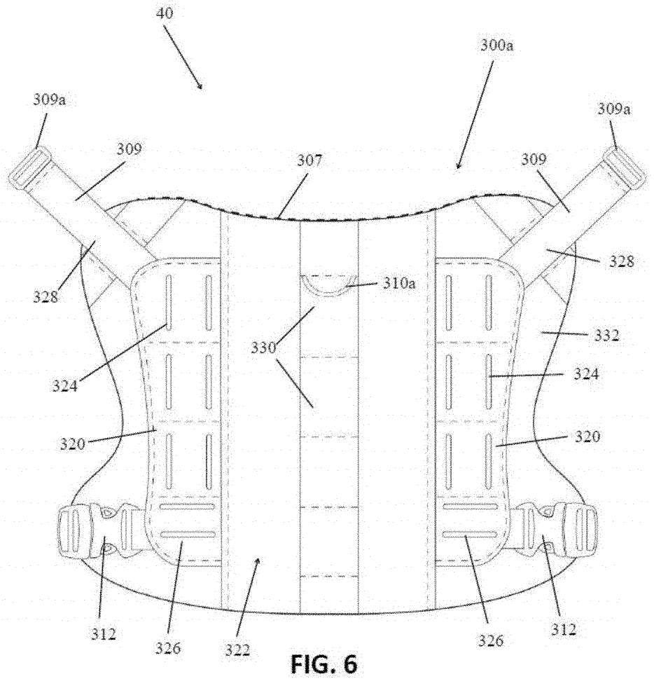

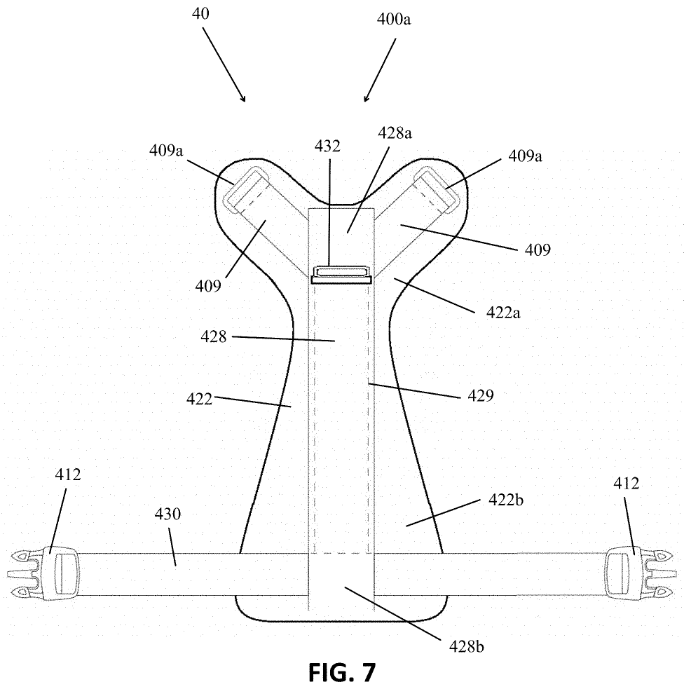

Referring to FIGS. 6 and 7, a further embodiment of a harness 40 of the present invention is shown. In this embodiment, with a few exceptions, the dorsal and ventral portions 300a, 400a are substantially identical to the dorsal and ventral portions 300, 400 in the embodiment described above and shown in FIGS. 4 and 5, which is incorporated by reference. Therefore, components that are identical to the previous embodiment are shown with the same element numbers. The modifications shown in FIGS. 6 and 7, and described below, were a result of further research and development, including actual testing of the harness 40 on animals.

As shown in FIG. 6, in this embodiment, the hook 310a is positioned on the strap or loop 330 toward a front section of the dorsal portion 330a. In this manner, it was found that stress is more evenly distributed on the animal 4 as well as the harness 40 when the leash 311 is pulled. Furthermore, the position of the hook 310a in this embodiment enables the lateral force exerted on the dorsal portion 330a to be distributed into the stronger seam on the neck line.

As shown in FIG. 7, in this embodiment, the shape of the ventral portion 400a is different in that a front portion 422a of the mesh 422 is tapered inward while the rear portion 422b of the mesh 422 is expanded outward. The front portion 422a is tapered to better accommodate legs of some animals by minimizing contact of the front portion 422a with the animal's armpits. The rear portion 422b is expanded outward to add more contact surface with the animal's underside and to reduce twisting of the rear portion 422b and the strap 430. As in the previous embodiment, the opening on the rear portion 428b could be used for further attaching items. Also, in this embodiment, an additional fastener 432 is provided on a front portion 428a of the lower region 428 for further attachment of accessories.

The harness 1, 2, 3, 40 of the present invention may incorporate other elements such as a name tag and/or a product label 202, as shown in FIGS. 1-2, and pockets (not shown). The harness 1, 2, 3, 40 could also include additional attachment means or members such as clips and rings to accommodate for a variety of additional accessories.

The harness 1, 2, 3, 40 of the present invention is shown in FIGS. 1-3 installed on a dog. However, the harness can be used on any four-legged animal and is not limited to house pets such as dogs, cats, and pet pigs. For example, the harness could be used on horses and other four-legged animals for different applications including for training and medical purposes.

The present invention may be embodied in other specific forms without departing from its spirit or essential characteristics. The described embodiments are to be considered in all respects only as illustrative and not restrictive. The scope of the invention will be, therefore, indicated by the claims rather than by the foregoing description. All changes which come within the meaning and range of equivalency of the claims are to be embraced within their scope.

What is claimed is:

1. An animal harness comprising:
a dorsal portion for fitting on a dorsal side of an animal;
a ventral portion for fitting on a ventral side of the animal; and
a first attachment member for removably attaching the dorsal portion to the ventral portion.

2. The animal harness of claim 1, wherein the dorsal portion and the ventral portion are portions of a single harness member.

3. The animal harness of claim 2, wherein the single harness member has a front opening for passing the head of the animal therethrough.

4. The animal harness of claim 1, wherein the first attachment member is selected from a zipper, a hook-and-loop fastener, a button, a hook, a buckle, and a clip.

5. The animal harness of claim 1, wherein the dorsal portion includes a hook for removably attaching a leash to the dorsal portion.

6. The animal harness of claim 1, wherein the dorsal portion includes a name tag.

7. The animal harness of claim 1, wherein the dorsal portion and the ventral portion form a front opening for passing the head of the animal therethrough.

8. The animal harness of claim 1, wherein the dorsal portion and the ventral portion form a side opening for passing a leg of the animal therethrough.

9. The animal harness of claim 1, wherein at least one of the dorsal portion and the ventral portion includes a second attachment member for removably attaching an item to the animal harness.

10. An animal harness comprising:
a dorsal portion for fitting on a dorsal side of an animal;
a ventral portion for fitting on a ventral side of the animal; and
a first attachment member on at least one of the dorsal portion and the ventral portion for removably attaching an item to the animal harness.

11. The animal harness of claim 10, wherein the dorsal portion and the ventral portion are portions of a single harness member.

12. The animal harness of claim 11, wherein the single harness member has a front opening for passing the head of the animal therethrough.

13. The animal harness of claim 10, further comprising a second attachment member for removably attaching the dorsal portion to the ventral portion.

14. The animal harness of claim 13, wherein the second attachment member is selected from a zipper, a hook-and-loop fastener, a button, a hook, a buckle, and a clip.

15. The animal harness of claim 10, wherein the dorsal portion includes a hook for removably attaching a leash to the dorsal portion.

16. The animal harness of claim 10, wherein the dorsal portion includes a name tag.

17. The animal harness of claim 10, wherein the dorsal portion and the ventral portion form a front opening for passing the head of the animal therethrough.

18. The animal harness of claim 10, wherein the dorsal portion and the ventral portion form a side opening for passing a leg of the animal therethrough.

19. The animal harness of claim 10, wherein the first attachment member is selected from a zipper, a hook-and-loop fastener, a button, a hook, a buckle, and a clip.

20. A method comprising:
positioning a dorsal portion adjacent to a ventral portion to form an animal harness having an opening;
passing a portion of an animal through the opening;
removably attaching the dorsal portion to the ventral portion using a first attachment member; and
removably attaching an item to the animal harness using a second attachment member.
